(19) United States
(12) Patent Application Publication
(10) Pub. No.: US 2025/0309442 A1
(43) Pub. Date: Oct. 2, 2025

(54) BATTERY MODULE

(71) Applicant: HONDA MOTOR CO., LTD., Tokyo (JP)

(72) Inventor: Wataru Ohira, Wako-shi (JP)

(21) Appl. No.: 19/087,880

(22) Filed: Mar. 24, 2025

(30) Foreign Application Priority Data
Mar. 26, 2024 (JP) 2024-049459

(51) Int. Cl. H01M 50/242; H01M 50/204; H01M 50/238; H01M 50/264

(52) U.S. Cl. CPC H01M 50/242; H01M 50/204; H01M 50/238; H01M 50/264; H01M 2220/20

(57) ABSTRACT

A battery module includes a cell stack that includes battery cells and heat exchangers stacked on the battery cells, and a holding mechanism that holds the cell stack by pressing both stacking-direction end portions of the cell stack inward in the stacking direction. The holding mechanism includes a damper member that presses the cell stack in the stacking direction.

### CROSS-REFERENCE TO RELATED APPLICATIONS

This application is based upon and claims the benefit of priority from Japanese Patent Application No. 2024-049459 filed on Mar. 26, 2024, the contents of which are incorporated herein by reference.

### BACKGROUND OF THE INVENTION

### Field of the Invention

The present disclosure relates to a battery module.

### Description of the Related Art

JP 2023-101130 A discloses a battery module including a cell stack formed by stacking battery cells and heat exchangers. The battery module further includes a battery frame as a holding mechanism that holds the cell stack by applying a tightening load from both sides of the cell stack. The battery frame prevents movement of the battery cells and the heat exchangers. The battery frame has a pair of spring plates and four rod-like connecting members for connecting the pair of spring plates with each other. The spring plate has four arm portions that project radially from a central portion.

### SUMMARY OF THE INVENTION

In the above-described conventional technique, the battery frame presses the cell stack in the stacking direction and thus the resonance frequency in the stacking direction is likely to be low. The problem is that when the resonance frequency is low, resonance is likely to occur.

The present disclosure aims to solve the aforementioned problems.

A battery module includes a cell stack that includes a battery cell and a heat exchanger stacked on the battery cell, and a holding mechanism that holds the cell stack by pressing both stacking-direction end portions of the cell stack inward in a stacking direction, wherein the holding mechanism includes a damper member that presses the cell stack in the stacking direction.

According to the present invention, because the holding mechanism having the damper member presses the cell stack in the stacking direction, the resonance frequency in the stacking direction of the cell stack can be increased. Therefore, the resonance of the cell stack due to external vibrations can be suppressed and thus the cell stack can be protected.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a battery module;

FIG. 2 is an exploded perspective view of a cell stack;

FIG. 3 is a cross-sectional view taken along the line III-III of FIG. 1;

FIG. 4 is a schematic view showing a mode in which an elastic body is fitted into a recessed portion provided at a holding plate;

FIG. 5 is a cross-sectional view of a battery module according to a modified example; and

FIG. 6 is a schematic diagram of an aircraft in which the battery module is mounted.

### DETAILED DESCRIPTION OF THE INVENTION

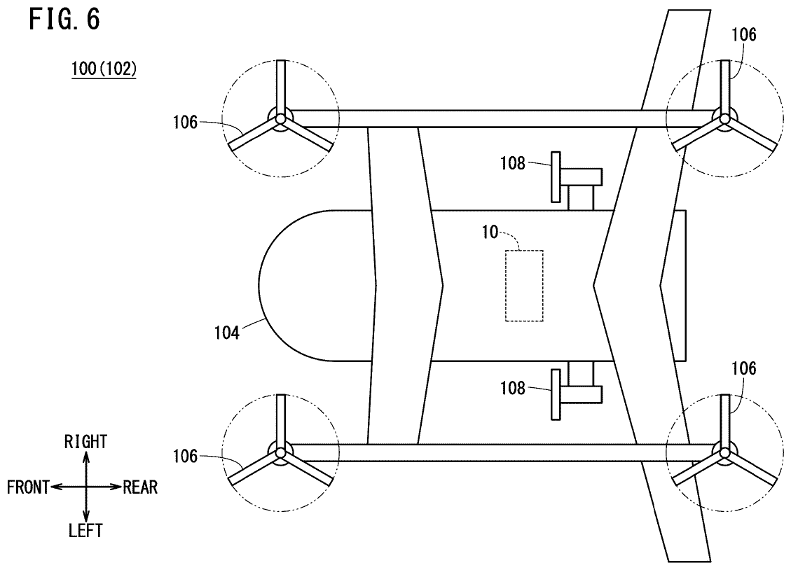

As shown in FIG. 6, a battery module 10 is mounted in, for example, an aircraft 102 as a mobile object 100. The aircraft 102 is, for example, an electric vertical take-off and landing (eVTOL) aircraft. The aircraft 102 includes a fuselage 104, multiple (for example, four) VTOL rotors 106, and multiple (for example, two) cruise rotors 108.

The VTOL rotor 106 generates an upward thrust force with respect to the aircraft 102. The cruise rotor 108 generates a horizontal thrust force with respect to the aircraft 102. The battery module 10 is placed inside the fuselage 104. The battery module 10 supplies power to an electric motor (not shown) that drives each of the VTOL rotors 106 and the cruise rotors 108. The mobile object 100 may also be, for example, a vehicle, a ship, or the like. The battery module 10 is not limited to the example where the battery module 10 is mounted in the mobile object 100.

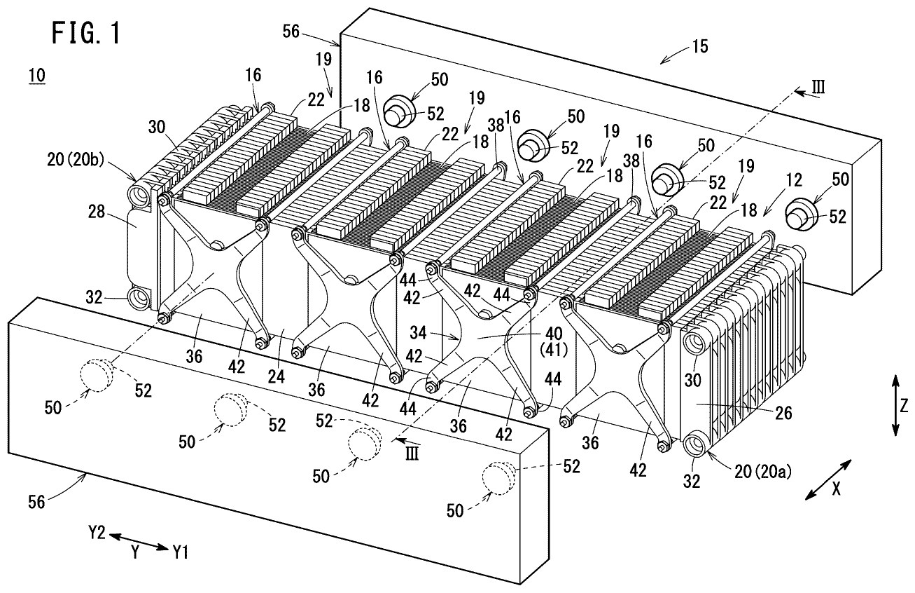

As shown in FIG. 1, the battery module 10 includes a cell stack 12 and a holding mechanism 15.

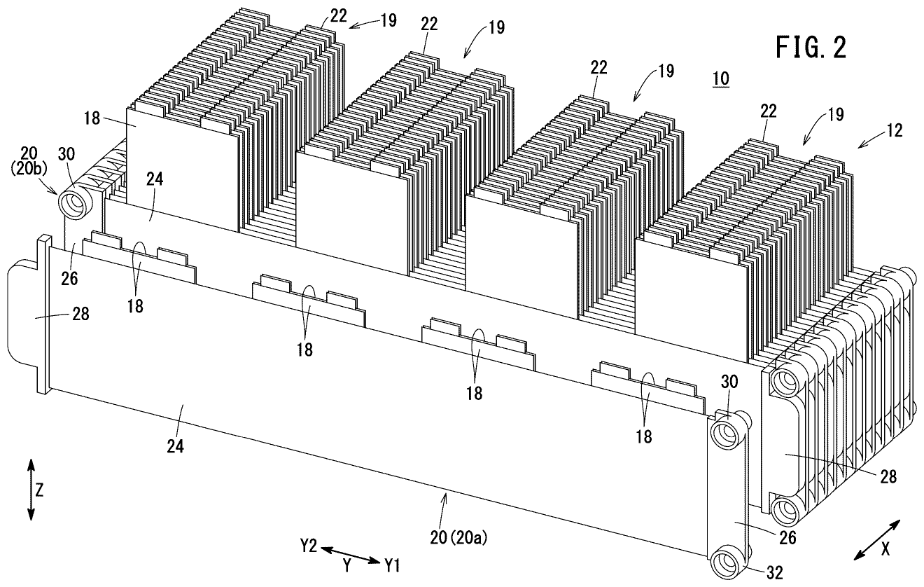

As shown in FIG. 2, the cell stack 12 includes a plurality of battery cells 18 and a plurality of heat exchangers 20. A single cell row 19 is formed of a plurality of battery cells 18 arranged in the direction of the arrow X. In this embodiment, four cell rows 19 are arranged in the direction of the arrow Y. The number of cell rows 19 may be three or less, or four or more. Only one cell row 19 may be provided in the battery module 10.

The battery cells 18 and the heat exchangers 20 are arranged (stacked) in the direction of the arrow X. In the following, the X direction is also referred to as the “stacking direction”. In addition, the direction toward the center of the battery module 10 in the X direction is expressed as “inward in the stacking direction”. The direction away from the center of the battery module 10 in the X direction is expressed as “outward in the stacking direction”.

The battery cell 18 is a laminate type battery. The battery cell 18 is formed in a rectangular plate shape. A plurality of terminal portions 22 project from one side of the battery cell 18, the side being in the direction of the arrow Z. The battery cells 18 are connected in series with each other via the terminal portions 22. The terminal portions 22 are conceptually illustrated. Electrical connecting members (not shown) are bonded to the terminal portions 22.

The heat exchangers 20 include a plurality of first heat exchangers 20a and a plurality of second heat exchangers 20b. As shown in FIG. 2, each first heat exchanger 20a has a plate-like water jacket 24, a water supply-drainage header 26, and a turn header 28. The water jacket 24 extends in the direction of the arrow Y. A flow path through which cooling water circulates is formed in the water jacket 24. Although not shown in detail, this flow path has a forward flow path for letting cooling water flow from the water supply-drainage header 26 toward the turn header 28 and a return flow path for letting cooling water flow from the turn header 28 toward the water supply-drainage header 26.

The water supply-drainage header 26 is one of a pair of headers provided in the first heat exchanger 20a. The water supply-drainage header 26 is provided at one end portion (Y1 direction side) in the longitudinal direction (direction of the arrow Y) of the water jacket 24. The water supply-drainage header 26 supplies cooling water to and discharges cooling water from the water jacket 24.

The water supply-drainage header 26 has a water supply port 30 and a water drain port 32. The water supply port 30 supplies cooling water to the forward flow path of the water jacket 24. The drain port 32 is provided at a lower portion of the water supply-drainage header 26. The water supply ports 30 of the first heat exchangers 20a adjacent to each other are connected liquid-tightly to each other. The drain port 32 discharges the cooling water from the return flow path of the water jacket 24. The drain ports 32 of the first heat exchangers 20a adjacent to each other are connected liquid-tightly to each other. Contrary to the above configuration, the water supply port 30 may be provided at the lower portion of the water supply-drainage header 26, and the water drain port 32 may be provided at the upper portion of the water supply-drainage header 26.

Although the details are not illustrated, the water supply ports 30 of the first heat exchangers 20a adjacent to each other are connected to be relatively movable in the X direction so that the expansion of the battery cells 18 in the X direction caused by heat generation or deterioration of the battery cells 18 can be absorbed. Similarly, the drain ports 32 of the first heat exchangers 20a adjacent to each other are connected to each other to be relatively movable in the X direction.

The turn header 28 is the other of a pair of headers provided in the first heat exchanger 20a. The turn header 28 is provided at the other end portion (Y2 direction side) of the water jacket 24 in the longitudinal direction. For this reason, the water jacket 24 is arranged between the water supply-drainage header 26 and the turn header 28. The turn header 28 receives cooling water from the forward flow path of the water jacket 24 and lets the cooling water flow to the return flow path of the water jacket 24.

The second heat exchanger 20b has a water jacket 24, a water supply-drainage header 26, and a turn header 28, as the first heat exchanger 20a. However, the second heat exchanger 20b is arranged in a different direction from the first heat exchanger 20a in the Y-direction. Therefore, in the case of the first heat exchanger 20a, the water supply-drainage header 26 is arranged on the Y2 direction side of the water jacket 24, and the turn header 28 is arranged on the Y1 direction side of the water jacket 24.

The first heat exchanger 20a and the second heat exchanger 20b are alternately arranged in the direction of the arrow X. Thus, the water supply-drainage header 26 of one of the first heat exchanger 20a and the second heat exchanger 20b and the turn header 28 of the other of the first heat exchanger 20a and the second heat exchanger 20b are adjacent to each other in the stacking direction (X direction).

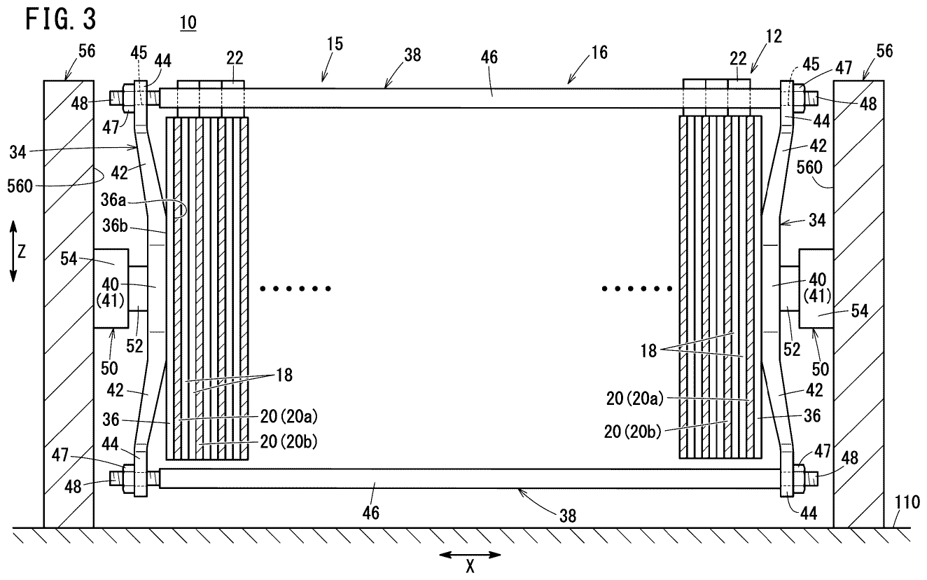

As shown in FIG. 3, two battery cells 18 are stacked in the direction of the arrow X between the first heat exchanger 20a and the second heat exchanger 20b that are adjacent to each other.

As shown in FIG. 1, in this embodiment, four battery frames 16 are provided corresponding to the four cell rows 19. The number of battery frames 16 may be three or less or five or more depending on the number of cell rows 19.

As shown in FIGS. 1 and 3, the holding mechanism 15 includes the battery frames 16, a plurality of damper members 50, and a pair of support members 56. The battery frame 16 includes at least a pair of holding plates 34, at least a pair of pressure receiving plates 36, and a plurality of connecting members 38. The pair of holding plates 34 are placed at the end portions of the battery module 10 in the direction of the arrow X.

The pair of holding plates 34 are located outward in the stacking direction of the battery cells 18. The holding plate 34 is made of, for example, titanium alloy. The holding plate 34 may be made of a metal material other than titanium alloy.

As shown in FIG. 1, the holding plate 34 is formed in an X-shape when viewed from the thickness direction (the direction of the arrow X) of the holding plate 34. The holding plate 34 has a point-symmetric shape. The holding plate 34 includes a plate central portion 40 and a plurality of arm portions 42.

As shown in FIG. 3, the plate central portion 40 is a pressing portion 41 that presses the cell stack 12 in the stacking direction via the pressure receiving plate 36. The plate central portion 40 is placed at a central portion of the holding plate 34. The plate central portion 40 is located more inward in the stacking direction than an arm tip portion 44, which is an end portion in the extending direction of the arm portion 42. Therefore, when viewed from the direction perpendicular to the stacking direction, the holding plate 34 as a whole has a shape that is convex inward in the stacking direction.

The arm portions 42 extend radially from the plate central portion 40. The arm portions 42 are provided at equal intervals in the circumferential direction of the plate central portion 40. The arm portion 42 is a leaf spring portion that is elastically deformed when a tightening load is applied to the cell stack 12. In this embodiment, the holding plate 34 has four arm portions 42. The number of arm portions 42 of the holding plate 34 may be three or less or five or more.

The connecting member 38 is connected to the arm tip portion 44, which is the end portion in the extending direction of the arm portion 42. The arm tip portion 44 is formed with an insertion hole 45 through which a bolt portion 48 of the connecting member 38 is inserted. The arm tip portion 44 is located more outward than the cell stack 12 when viewed from the stacking direction (the direction of the arrow X) of the battery cells 18. The arm tip portion 44 does not overlap with the terminal portions 22 when viewed from the direction of the arrow X.

The elastic force (spring force) of the four arm portions 42 is applied to the cell stack 12 as the tightening load via the pressure receiving plate 36. This tightening load is the holding force of the holding plate 34 with respect to the cell stack 12. The battery frame 16 holds the cell stack 12 by the frictional force generated by the force of the holding plate 34 pushing the cell stack 12 via the pressure receiving plate 36.

The pressure receiving plate 36 is a pressing plate for evenly applying to the cell stack 12 the tightening load exerted from the holding plate 34. The pressure receiving plate 36 is placed between the holding plate 34 and the cell stack 12. When viewed from the stacking direction, the pressure receiving plate 36 is formed in a quadrilateral shape. The pressure receiving plate 36 is not essential. Therefore, the cell stack 12 may be directly pressed by the plate central portion 40 without the pressure receiving plate 36 being provided.

A first surface 36a of the pressure receiving plate 36 facing the cell stack 12 is in surface contact with an end surface of the cell stack 12. A second surface 36b of the pressure receiving plate 36 facing in the direction opposite to the cell stack 12 is in surface contact with the plate central portion 40 of the holding plate 34.

As shown in FIG. 1, with the holding plate 34 being attached to the pressure receiving plate 36, the four arm portions 42 extend, overlapping respectively with four corner portions of the pressure receiving plate 36 when viewed in the direction of the arrow X. With the holding plate 34 being attached to the pressure receiving plate 36, a gap is provided between the arm portion 42 and the corner portions of the pressure receiving plate 36. With the holding plate 34 being attached to the pressure receiving plate 36, the four arm tip portions 44 are located more outward than the pressure receiving plate 36 when viewed in the direction of the arrow X.

The plurality of connecting members 38 connect the pair of holding plates 34 to each other in such a way that the tightening load (compressive load) is applied from the pair of holding plates 34 to the cell stack 12. In this embodiment, the battery frame 16 has four connecting members 38. Each connecting member 38 is a shaft that extends along the stacking direction of the battery cells 18. The connecting member 38 is made of, for example, a metallic material, such as stainless steel.

As shown in FIG. 3, each connecting member 38 includes a connecting shaft 46 and two nuts 47. The connecting shaft 46 extends along the stacking direction of the battery cells 18. The connecting shaft 46 is made of, for example, a metallic material, such as stainless steel.

The connecting shaft 46 is provided with the bolt portions 48 at both axial end portions. The bolt portion 48 is inserted through the insertion hole 45 of the arm tip portion 44. The nut 47 is screwed into the bolt portion 48. When the nut 47 is tightened to the bolt portion 48, the holding plate 34 is pressed toward the pressure receiving plate 36. At this time, the four arm portions 42 are elastically deformed.

The pair of damper members 50 press the cell stack 12 inward in the stacking direction via the pair of holding plates 34 and the pair of pressure receiving plates 36. Thus, each holding plate 34 is placed between the cell stack 12 and the damper member 50. The damper member 50 presses the holding plate 34 against the cell stack 12. Each damper member 50 has an elastic body 52 and a holder 54.

The elastic body 52 is a damper body. The elastic body 52 is formed of a material exhibiting rubber elasticity. The elastic body 52 is made of a rubber material or an elastomer material. The elastic body 52 is in contact with the holding plate 34. The elastic body 52 has a circular shape when viewed from the stacking direction. The elastic body 52 may have an elliptical shape or a polygonal shape when viewed from the stacking direction.

In this embodiment, the elastic body 52 is in contact with the plate central portion 40 of the holding plate 34. The elastic body 52 may abut against at least one arm portion 42 of the holding plate 34. The holder 54 holds the elastic body 52. The holder 54 is formed of a material with higher rigidity than the elastic body 52. The holder 54 is made of, for example, metal.

As shown in FIG. 1, a plurality of damper members 50 are arranged with a space between each other in the Y direction. Specifically, the damper members 50 are respectively arranged at positions overlapping the cell rows 19 when viewed from the stacking direction (X direction). In this embodiment, because the four cell rows 19 are arranged in the Y direction, four damper members 50 are arranged in the Y direction.

The pair of support members 56 support the damper members 50, respectively. As shown in FIG. 3, each support member 56 has an opposing surface 560 that faces the holding plate 34. The damper member 50 is fixed to the opposing surface 560. Thus, the damper member 50 is placed between the holding plate 34 and the support member 56. Although not shown in detail, the damper members 50 are fixed to the pair of support members 56 with appropriate fixing components (for example, bolts). Each support member 56 is fixed to a floor 110 of an installation target (for example, the mobile object 100 shown in FIG. 6) in which the battery module 10 is installed.

According to the present embodiment, the following effects are obtained.

As described above, the holding mechanism 15 of the battery module 10 has the damper member 50 that presses the cell stack 12 in the stacking direction. According to such a configuration, because the holding mechanism 15 having the damper member 50 presses the cell stack 12 inward in the stacking direction, the resonance frequency of the cell stack 12 in the stacking direction can be increased. Therefore, the resonance of the cell stack 12 caused by the external vibration is suppressed and thus the cell stack 12 can be protected.

The holding plate 34 is positioned between the cell stack 12 and the damper member 50. The damper member 50 presses the holding plate 34 against the cell stack 12. According to such a configuration, because the damper member 50 and the holding plate 34 apply a tightening load to the cell stack 12, the resonance frequency of the cell stack 12 can be effectively increased.

The holding mechanism 15 has the support member 56 that supports the damper member 50. According to such a configuration, in addition to the tightening load applied by the pair of holding plates 34, the tightening load applied by the damper member 50 supported by the support member 56 can be applied to the cell stack 12. Thus, the resonant frequency of the cell stack 12 can be effectively increased.

The damper member 50 presses the plate central portion 40 (pressing portion 41) of the holding plate 34 against the cell stack 12. According to such a configuration, the influence of the vibration at the arm portion 42 of the holding plate 34 can be reduced and thus the resonance frequency of the cell stack 12 can be effectively increased.

Compared with the case where the damper member 50 is not provided, the damper member 50 increases the resonance frequency in the stacking direction of the cell stack 12. The present inventor conducted experiments to confirm such an effect of the damper member 50. In the experiment, a gravity sensor was attached to the cell stack 12 and then a hammer was used to hit the cell stack 12. The resonance frequency was measured using a FFT analyzer (DS-5000) manufactured by ONO SOKKI Co., Ltd., based on the inputs of the hammer and the outputs of the gravity sensor. As a result, the resonance frequency in the case where the damper member 50 was not provided was 95 Hz whereas the resonance frequency in the case where the damper member 50 was provided was 220 Hz. Thus, it has been confirmed that the damper member 50 can increase the resonance frequency in the stacking direction of the cell stack 12.

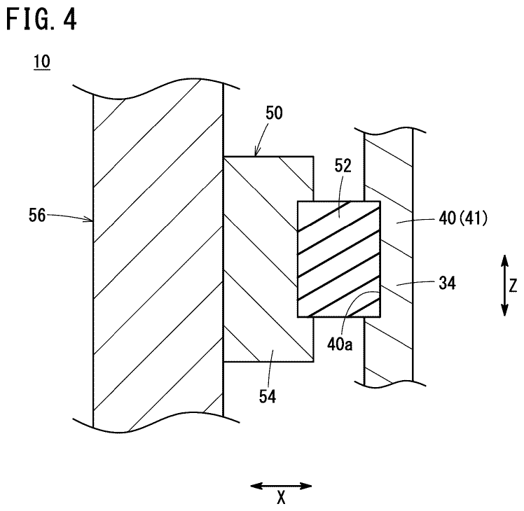

As shown in FIG. 4, the plate central portion 40 may have a recessed portion 40a. In this case, the damper member 50 (elastic body 52) is fitted in the recessed portion 40a. The recessed portion 40a has the same shape as the elastic body 52 when viewed from the stacking direction (X direction). When viewed in the stacking direction, the elastic body 52 and the recessed portion 40a have substantially the same size. According to such a configuration, even when the battery module 10 receives an impact, it is possible to prevent the occurrence of a relative displacement (positional shift) between the damper member 50 and the holding plate 34 in the direction perpendicular to the stacking direction. Therefore, the effect of increasing the resonance frequency of the cell stack 12 can be stably exhibited.

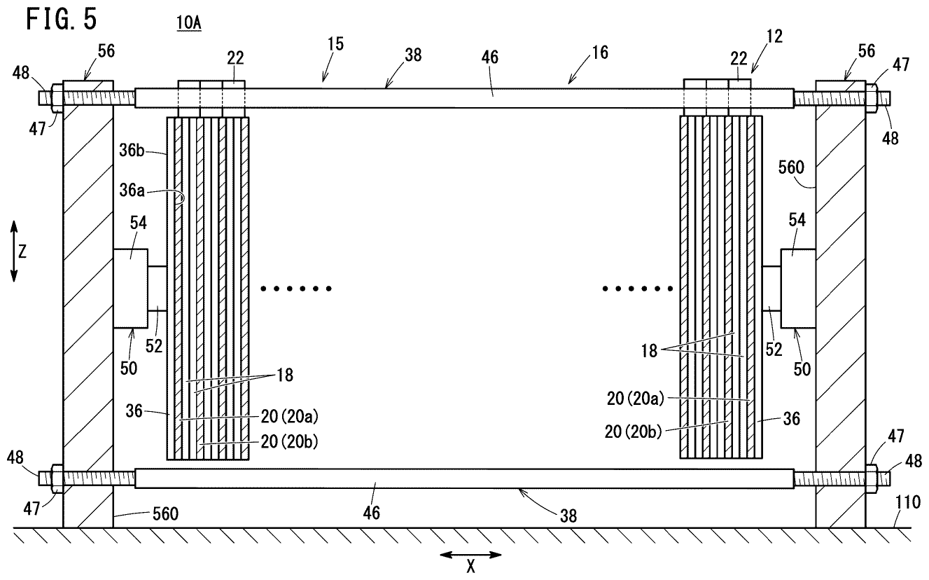

Although the battery module 10 of the above-described mode has the holding plate 34, the holding plate 34 may be omitted. The configuration in this case is shown in FIG. 5. As shown in FIG. 5, a battery module 10A according to a modified example has a plurality of connecting members 38 connected to a pair of support members 56. A clamping load is applied to the cell stack 12 via the pressure receiving plate 36 by the damper members 50 supported on the pair of support members 56, respectively. In this case, the tightness of the nut 47 with respect to the bolt portion 48 is adjusted, whereby the desired tightening load is acquired. It should be noted that the plurality of connecting members 38 may be fixed to the pair of support members 56 in a non-adjustable manner and instead, the support members 56 may be fixed to the floor 110 in an adjustable manner.

With respect to the above embodiments, we further disclose the following supplementary note.

### (Supplementary Note 1)

The battery module (10, 10A) of the present disclosure includes the cell stack (12) that includes the battery cell (18) and the heat exchanger (20) stacked on the battery cell, and the holding mechanism (15) that holds the cell stack by pressing both stacking-direction end portions of the cell stack inward in the stacking direction, wherein the holding mechanism includes the damper member (50) that presses the cell stack in the stacking direction.

### (Supplementary Note 2)

Regarding the battery module according to Supplementary note 1, the holding mechanism may include the holding plate (34) that is elastically deformable and the damper member, the holding plate may be arranged between the cell stack and the damper member, and the damper member may press the holding plate against the cell stack.

### (Supplementary Note 3)

Regarding the battery module according to Supplementary note 2, a pair of the holding plates may be arranged on both sides of the cell stack in the stacking direction, and the holding mechanism may include a plurality of connecting members (38) that connect the pair of the holding plates to each other, and the support member (56) that supports the damper member.

### (Supplementary Note 4)

Regarding the battery module according to Supplementary note 2, the holding plate may include a pressing portion (41) and a plurality of arm portions (42) that extend radially from the pressing portion, and the damper member may press the pressing portion against the cell stack.

### (Supplementary Note 5)

Regarding the battery module according to Supplementary note 4, the pressing portion may include a recessed portion (40a), and the damper member may fit in the recessed portion.

### (Supplementary Note 6)

Regarding the battery module according to any one of Supplementary notes 2 to 5, the damper member may increase the resonance frequency of the cell stack in the stacking direction in comparison with a case where the damper member is omitted.

### (Supplementary Note 7)

Regarding the battery module according to any one of Supplementary notes 1 to 5, the damper member may include an elastic body (52) that exhibits rubber elasticity.

### (Supplementary Note 8)

Regarding the battery module according to any one of Supplementary notes 2 to 5, the damper member may include an elastic body that exhibits rubber elasticity and abuts against the holding plate.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A battery module comprising:
a cell stack configured to include a battery cell and a heat exchanger stacked on the battery cell; and
a holding mechanism configured to hold the cell stack by pressing both stacking-direction end portions of the cell stack inward in a stacking direction of the cell stack,
wherein the holding mechanism includes a damper member configured to press the cell stack in the stacking direction.

2. The battery module according to claim 1, wherein
the holding mechanism includes:
a holding plate configured to be elastically deformable; and
the damper member,
the holding plate is arranged between the cell stack and the damper member, and
the damper member presses the holding plate against the cell stack.

3. The battery module according to claim 2, wherein
a pair of the holding plates are arranged on both sides of the cell stack in the stacking direction, and
the holding mechanism includes a plurality of connecting members configured to connect the pair of the holding plates to each other, and a support member configured to support the damper member.

4. The battery module according to claim 2, wherein
the holding plate includes a pressing portion and a plurality of arm portions configured to extend radially from the pressing portion, and
the damper member presses the pressing portion against the cell stack.

5. The battery module according to claim 4, wherein
the pressing portion includes a recessed portion, and
the damper member fits in the recessed portion.

6. The battery module according to claim 2, wherein
the damper member increases a resonance frequency of the cell stack in the stacking direction in comparison with a case where the damper member is omitted.

7. The battery module according to claim 1, wherein
the damper member includes an elastic body configured to exhibit rubber elasticity.

8. The battery module according to claim 2, wherein
the damper member includes an elastic body configured to exhibit rubber elasticity and abut against the holding plate.
